(19) United States
(12) Patent Application Publication
(10) Pub. No.: US 2023/0385676 A1
(43) Pub. Date: Nov. 30, 2023

(54) SYSTEMS AND METHODS FOR IMPLEMENTING QUANTUM WALKS IN DISTRIBUTED QUANTUM COMPUTING

(71) Applicant: Mellanox Technologies, Ltd., Yokneam (IL)

(72) Inventors: Elad Mentovich, Tel Aviv (IL); Kyle Michael Scheps, Geneva (CH)

(21) Appl. No.: 17/828,854

(22) Filed: May 31, 2022

(51) Int. Cl. G06N 10/60; G06N 10/40

(52) U.S. Cl. CPC G06N 10/60; G06N 10/40

(57) ABSTRACT

A distributed quantum computing system formed of a plurality of quantum processing units (QPUs) is provided for performing quantum walks. An example first QPU includes a first plurality of physical qubits propagating across a first plurality of nodes where at least a portion of the first plurality of nodes are local nodes configured to perform the one or more quantum walks on the first QPU. The one or more quantum walks are conducted across the first plurality of nodes of at least the first QPU so as to form a graphical structure. Performance of the one or more quantum walks on the first QPU further includes propagation of at least a portion of the first plurality of physical qubits across the first plurality of nodes responsive to one or more inputs from evolution operators.

### TECHNOLOGICAL FIELD

Example embodiments of the present disclosure relate generally to quantum computing and, more particularly, to distributed quantum computing applications for implementing quantum walks.

### BACKGROUND

Quantum computing applications leverage the laws of quantum mechanisms (e.g., superposition, entanglement, etc.) to complete or otherwise solve certain computational problems exponentially faster than the capabilities of classical computers. Applicant has identified a number of deficiencies and problems associated with quantum computing, particularly when applied to distributed computing environments. Through applied effort, ingenuity, and innovation, many of these identified problems have been solved by developing solutions that are included in embodiments of the present disclosure, many examples of which are described in detail herein.

### BRIEF SUMMARY

Systems, apparatuses, and methods are disclosed herein for implemented quantum walks in distributed quantum computing environments. An example apparatus of the present disclosure may include a first quantum processing unit (QPU) configured to perform one or more quantum walks. The first QPU may include a first plurality of physical qubits propagating across a first plurality of nodes, and at least a portion of the first plurality of nodes may be local nodes configured to perform the one or more quantum walks on the first QPU.

In some embodiments, at least a portion of the first plurality of physical qubits may be synchronization qubits configured to determine if the one or more quantum walks performed by the first QPU are in sync.

In some further embodiments, the synchronization qubits may be independent of the physical qubits propagating across the local nodes performing the one or more quantum walks.

In some embodiments, the apparatus may further include a second QPU in communication with the first QPU via a quantum channel and configured to perform the one or more quantum walks. The second QPU may include a second plurality of physical qubits propagating across a second plurality of nodes, and at least a portion of the second plurality of nodes may be local nodes configured to perform the one or more quantum walks on the second QPU.

In some further embodiments, the first QPU and the second QPU may operate in parallel to perform the one or more quantum walks.

In some further embodiments, at least a portion of the second plurality of physical qubits of the second QPU may be synchronization qubits. In such an embodiment, the synchronization qubits of the first QPU and the synchronization qubits of the second QPU may be further configured to determine if the one or more quantum walks performed by the first QPU and the one or more quantum walks performed by the second QPU are in sync.

In some further embodiments, a portion of the first plurality of nodes of the first QPU may be global nodes, and a portion of the second plurality of nodes of the second QPU may be global nodes. In such an embodiment, the global nodes of the first QPU may be configured to perform the one or more quantum walks in conjunction with the global nodes of the second QPU.

In some still further embodiments, at least a portion of the first plurality of physical qubits of the first QPU and at least a portion of the second plurality of physical qubits of the second QPU may be entangled.

In some embodiments, the one or more quantum walks described herein may be discrete-time quantum walks or continuous-time quantum walks.

In some embodiments, the one or more quantum walks may be conducted across the first plurality of nodes of at least the first QPU so as to form a graphical structure. In such an embodiment, performance of the one or more quantum walks on the first QPU may include propagation of at least a portion of the first plurality of physical qubits across the first plurality of nodes responsive to one or more inputs from evolution operators.

In some embodiments, the apparatus may further include a computer processing device in communication with the first QPU and the second QPU. The computer processing device may be configured to receive data generated by the one or more quantum walks performed by the first QPU and the second QPU.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example distributed quantum computing system in accordance with one or more embodiments of the present disclosure;

FIGS. 2A-2D illustrate example quantum processing units (QPU) having a plurality of physical qubits propagating across a first plurality of nodes that include local nodes for performing local quantum walks in accordance with one or more embodiments of the present disclosure;

FIG. 3 illustrates an example QPU having synchronization qubits (e.g., a portion of the plurality of physical qubits) and local and global nodes (e.g., portions of the first plurality of nodes) in accordance with one or more embodiments of the present disclosure;

FIGS. 3A-3C illustrate an example physical qubit propagating across a plurality of nodes of an example QPU;

FIGS. 4A-4C illustrate example distributed QPU implementations having two (2) QPUs in accordance with one or more embodiments of the present disclosure;

FIG. 5 illustrates an example distributed QPU implementation having three (3) QPUs in accordance with one or more embodiments of the present disclosure;

FIGS. 6A-6B illustrate example distributed QPU implementations having four (4) QPUs in accordance with one or more embodiments of the present disclosure;

FIG. 7 illustrates an example graphics processing unit/computer processing device for use with some of the example embodiments described herein; and

FIG. 8 illustrates a flowchart of an example method for performing distributed quantum computing with quantum walks in accordance with one or more embodiments of the present disclosure.

### DETAILED DESCRIPTION

### Overview

Quantum computers represent an emerging type of computer that leverage the laws of quantum mechanics, such as superposition and entanglement, to solve certain computing problems exponentially faster than classical computers (e.g., transistor-based computers). In a quantum computer, the basic units of information are quantum bits (qubits), which are the quantum analog of binary bits in a classical computer. In general, the processing power of a quantum computer may be increased by increasing the number of qubits on the quantum computer. The complexities of quantum mechanics, however, have severely limited the number of qubits that may be placed on current quantum computers without compromising the functioning of the quantum computer, thus, limiting the processing power of current quantum computers. In current quantum computers, for example, increasing the number of qubits may result in a corresponding increase in the output noise of the quantum computer. As the output noise of the quantum computer increases, the solution generated by the quantum computer may become difficult to ascertain in light of the associated noise. Accordingly, in order for quantum computers to reach their full potential, solutions are needed to overcome the qubit limitation of quantum computers imposed by the complexities of quantum mechanics.

One attempt at overcoming the qubit limitation of quantum computers is to create a distributed quantum computing system that includes multiple separate quantum computers that are each classically connected (e.g., via a computer bus or equivalent classical method for connectivity) to a classical computer. In such a distributed quantum computing system, the system as a whole may have a greater number of qubits, and corresponding processing power, than a single quantum computer. Since such a distributed system has access to qubits from multiple quantum computers, the noise generated by any particular quantum computer may be practically limited so as to prevent any detrimental impact of such noise on the operations of these quantum computers. Moreover, distributed quantum computing may provide substantial noise reduction due to the shallower depth associated with these systems. The distributed quantum computing system may be able to avoid the challenges faced by single quantum computers. Combining multiple quantum computers into a distributed quantum computing system and implementing quantum algorithms on such a system has presented new challenges not anticipated by conventional quantum computing implementations.

A new class of quantum algorithms are being devised to efficiently solve problems in a wide variety of fields (e.g., molecular biology, fundamental physics, finance, etc.) termed quantum walks. A quantum walk is the quantum analog of the classical random walk as implemented in classical computers (e.g., transistor-based computers) in which, for example, probabilities determine the exact state that will exist at each point of time, and a transition matrix is determined to capture the evolution. In contrast, for quantum walks, the state for a qubit at each timestep exists in a superposition of all possible values before collapsing to a single state only upon observation.

Quantum walks offer a universal computational basis for quantum computing (i.e., any quantum computation may be solved using quantum walks). As such, quantum walkers are quantum computers designed specifically to run quantum walks, rather than operating upon the traditional quantum circuit model. In operation for quantum walks, the particle undergoing the quantum walk operates as the first qubit possessing two (2) degrees of freedom. The positional space on which the quantum walk is performed encodes the remaining qubits. A positional space of two (2) nodes represents a second qubit also having two (2) degrees of freedom (e.g., each state of this second qubit is mapped onto each node of the walk), a positional space of four (4) nodes represented as third qubits, etc. Quantum walkers where more than a single physical particle exist may operate to reduce the number of nodes required to encode additional qubits. The mapped qubits may be used to construct any quantum circuit or geometry using a universal basis of single qubit gates as a controlled gate. In other words, the quantum walks described herein may be mapped by encoding the walks into either a shift or coin operator (e.g., evolution operators) and then enacting these operators as position-dependent (i.e., enacting different forms of the shift or coin operators onto different nodes). Similar to the noise generation concerns described above, however, increasing the number of nodes on a single quantum computer in order to capture the increasing degrees of freedom results in an exponential increase of nodes that are often inefficient.

Thus, to address these and/or other issues, the embodiments of the present disclosure provide quantum processing units (QPUs) for implementing as part of a distributed quantum computing network. For example, the embodiments of the present disclosure may leverage at least a first QPU formed as part of a distributed quantum computing network that has a plurality of qubits. At least a portion of these qubits of the first QPU may be configured to perform one or more quantum walks. As part of this distributed network, a second QPU in communication with the first QPU via a quantum channel may be used, and the second QPU may include a second plurality of qubits configured to perform the quantum walks on the second QPU. In doing so, the embodiments of the present disclosure provide for graphical structures of nodes that are entirely flexible and scalable based upon the number of qubits to solve a particular problem (e.g., quantum algorithm) supplied to the network of distributed quantum processing units.

The embodiments described herein further provide for time synchronization amongst the distributed QPUs that form the quantum processing network or system. For example, a first QPU performing the quantum walk via one or more local nodes of the first QPU may further include one or more synchronization qubits that are independent of the local nodes performing the quantum walk. Similarly, a second QPU performing the quantum walk via one or more local nodes of the second QPU may also include one or more synchronization qubits that are independent of the local nodes performing the quantum walk. By utilizing these synchronization qubits, a system (e.g., a classical computer communicably coupled with the first and the second QPUs) may determine if the quantum walks performed by these distributed components are in sync. For example, the system may determine that respective qubits do not exist on the same timestep for discrete quantum walks, that the QPUs are therefore not in sync, and that the quantum walk operations are to be restarted.

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. Furthermore, as would be evident to one of ordinary skill in the art in light of the present disclosure, the terms “substantially” and “approximately” indicate that the referenced element or associated description is accurate to within applicable engineering tolerances.

### Distributed Quantum Computing System

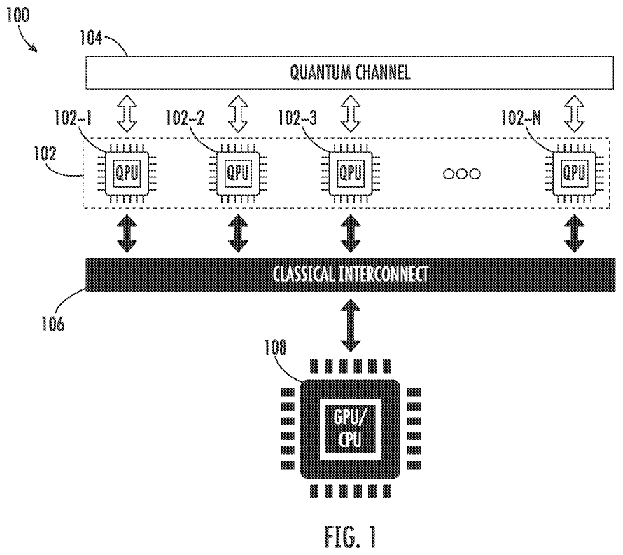

Embodiments herein provide for an example distributed quantum computing system 100 for implementing quantum walks. In some embodiments, as shown in FIG. 1, the distributed quantum computing system 100 (e.g., system 100) may include one or more quantum processing units (QPUs) 102 each configured to perform one or more quantum walks. As shown, the QPUs 102 may include a first QPU 102-1, a second QPU 102-2, a third QPU 102-3, a fourth QPU 102-4, . . . , a N^{th} QPU 102-N. Although described hereinafter with reference to a defined number of QPUs 102, the present disclosure contemplates that any number of QPUs 102 may be used based upon the intended application of the distributed quantum computing system 100. In some embodiments, the one or more QPUs 102 may be in communication via a quantum channel 104 configured to transmit quantum information (e.g., qubits) and/or classical information (e.g., binary bits) between the one or more QPUs 102. Although illustrated and described herein with reference to a single quantum channel 104, the present disclosure contemplates that the distributed quantum computing system 100 may include any number of interconnected or distinct quantum channels 104 based upon the intended application of the distributed quantum computing system 100.

In some embodiments, some or all of the one or more QPUs 102 may be embodied on a single device. In other embodiments, some or all of the one or more QPUs 102 may be separate devices that are physically separated (e.g., remotely connected via the quantum channel 104). In some embodiments, the distributed quantum computing system 100 may include a graphical processing unit (GPU), a computer processing device (“CPU”) 108, and/or any computing device (e.g., a classical computer) in communication with the one or more QPUs 102 via a classical interconnect 106 (e.g., a computer bus). In some embodiments, the GPU/CPU 108 may be physically separate from the one or more QPUs 102 and configured to remotely connect to the one or more QPUs 102 via the classical interconnect 106. In some embodiments, the GPU/CPU 108 may be configured to interface the distributed quantum computing system 100 with other classical and/or quantum computers. For example, the distributed quantum computing system 100 may be a portion of a high-performance computing network.

In some embodiments, the GPU/CPU 108 may be configured to instruct the one or more QPUs 102 to perform one or more quantum walks via instructions transmitted via the classical interconnect 106. For example, in some embodiments, a user or operator associated with the distributed quantum computing system 100 may connect to the distributed quantum computing system 100 via the GPU/CPU 108 and may use the GPU/CPU 108 to perform the quantum walk(s) on the distributed quantum computing system 100. In some embodiments, the distributed quantum computing system 100 may be configured to perform multiple quantum walks concurrently. In this regard, for example, the distributed quantum computing system 100 may be configured such that a portion of the one or more QPUs 102 may perform quantum walk operations for a first purpose, while another portion on the one or more QPUs 102 may perform quantum walk operations for a second, different purpose. In some embodiments, the GPU/CPU 108 may be configured to receive data generated by the QPUs 102 following completion of the quantum walks performed by these QPUs 102 In some embodiments, the GPU/CPU 108 may be configured to display this data and/or one or more solutions to quantum algorithms that rely upon successful quantum walk performance to the user or operator associated with the distributed quantum computing system 100 and/or to other classical and/or quantum computers connected to the distributed quantum computing system 100.

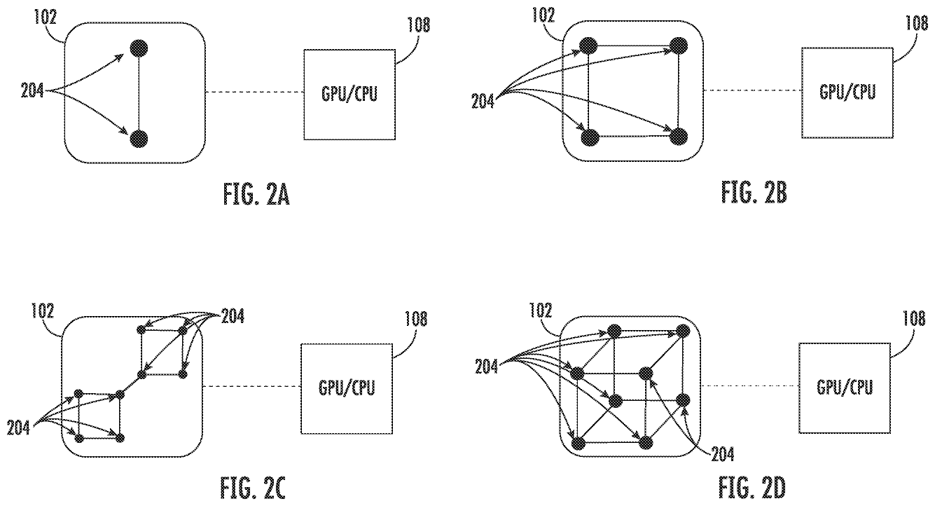

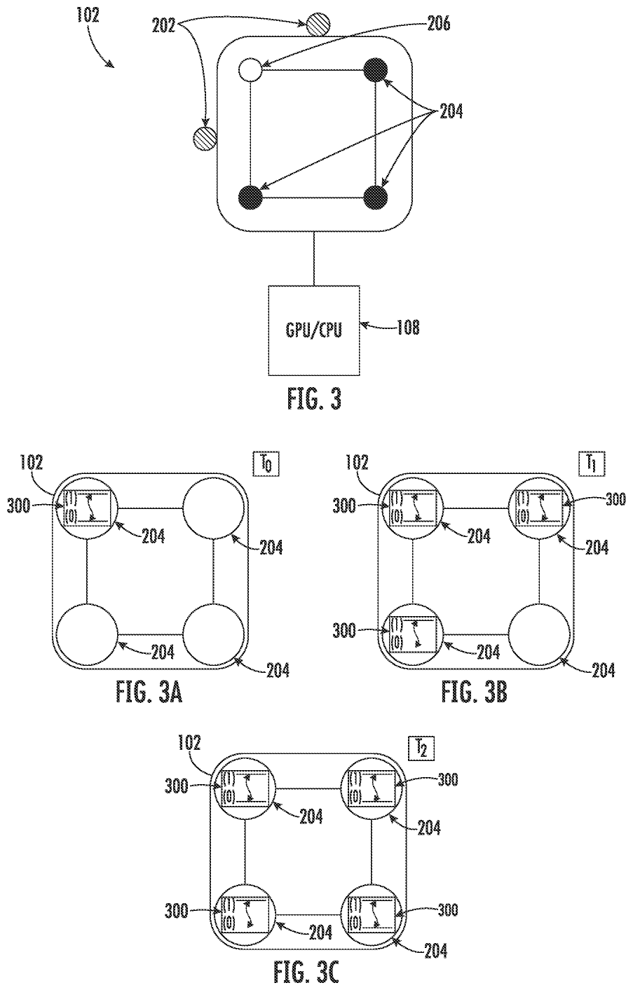

With reference to FIGS. 2A-2D, example first QPUs 102 are illustrated coupled with a GPU/CPU 108 as described above. As shown, the first QPU 102 includes a first plurality of physical qubits propagating across a first plurality of nodes. The first plurality of nodes includes at least local nodes (e.g., local quantum walk or local walk nodes) 204. As described hereafter with reference to FIG. 3, each QPU 102 of the system 100 may include physical qubits (e.g., other qubits of the first plurality of physical qubits associated with each QPU 102) that are configured for other purposes as described herein. As such, the local nodes 204 of the first QPU 102 illustrated in FIGS. 2A-2D represent a portion of the first plurality of nodes associated with the first QPU 102. As described above, the local nodes 204 may be configured to perform the one or more quantum walks on the first QPU 102. Although described herein with reference to performance of the quantum walks, the present disclosure contemplates that performing the quantum walks may equally refer to the any node of the QPU 102 undergoing a quantum walk.

Quantum walks represent an emerging class of quantum algorithms that efficiently solve problems in a wide variety of fields (e.g., molecular biology, fundamental physics, finance, etc.). A quantum walk is the quantum analog of the classical random walk as implemented in classical computers (e.g., transistor-based computers) in which, for example, probabilities determine the exact state that will exist at each point of time, and a transition matrix is determined to capture the evaluation. In contrast, for quantum walks, the state for a qubit at each timestep exists in a superposition of all possible values before collapsing to a single state only upon observation. As described above, the particle undergoing the quantum walk operates as the first qubit possessing two (2) degrees of freedom. The positional space on which the quantum walk is performed encodes the remaining qubits. A positional space of two (2) nodes represents a second qubit also having two (2) degrees of freedom (e.g., each state of this second qubit is mapped onto each node of the walk), a positional space of four (4) nodes represented as third qubits, etc.

Quantum walkers where more than a single physical particle exist may operate to reduce the number of nodes required to encode additional qubits. The mapped qubits may be used to construct any quantum circuit or geometry using a universal basis of single qubit gates as a controlled gate. In other words, the quantum walks described herein may be mapped by encoding the walks into either a shift or coin operator (e.g., evolution operators) and then enacting these operators as position-dependent (i.e., enacting different forms of the shift or coin operators onto different nodes). Although described herein with reference to example discrete time quantum walks, the present disclosure contemplates that the principle of the presently disclosed embodiment may be equally applicable to continuous-time quantum walks.

Performance of the one or more quantum walks by the local nodes 204 includes conducting the quantum walks across the first plurality of nodes as described hereafter of at least the first QPU 102. In doing so, the first plurality of nodes described herein operate to form a graphical structure that may vary based upon the intended problem (e.g., quantum algorithm or the like) to be ultimately completed by the system 100. Furthermore, performance of the one or more quantum walks on the first QPU 102 includes propagation of at least a portion of the first plurality of physical qubits across the plurality of nodes (e.g., local nodes 204) responsive to one or more inputs from evolution operators (e.g., shift and/or coin operators as described above). In doing so and as further illustrated in the various topologies provided herein, the embodiments of the present disclosure provide flexibility and scalability not found in conventional implementations.

With reference to FIG. 2A, a two (2) qubit quantum walk based QPU 102 is illustrated. Each of the two local nodes 204 represents a node that is accessible by a physical qubit during performance of a quantum walk. As such, one physical qubit walking across two (2) nodes represents two qubits (e.g., two (2) local nodes 204). With reference to FIG. 2B, a three (3) qubit quantum walk based QPU 102 is illustrated. The illustrated three (3) qubit implementation includes four (4) nodes. Furthermore, these four (4) nodes are arranged on a square walk topology (e.g., graphical structure). With reference to FIG. 2C, a four (4) qubit quantum walk based QPU 102 is illustrated. The illustrated four (4) qubit implementation includes eight (8) nodes. Furthermore, these eight (8) nodes are arranged on a planar walk topology (e.g., graphical structure). With reference to FIG. 2D, another, alternative four (4) qubit quantum walk based QPU 102 is illustrated. The illustrated four (4) qubit implementation includes eight (8) arranged on a cubic walk topology (e.g., graphical structure). As evident by the various topologies illustrated in FIGS. 2A-2D, the embodiments of the present disclosure provide for various exotic and sophisticated QPU topologies. These topologies may be further complexed with the addition of other physical qubits (e.g., synchronization qubits) and other nodes (e.g., global nodes) as described hereafter.

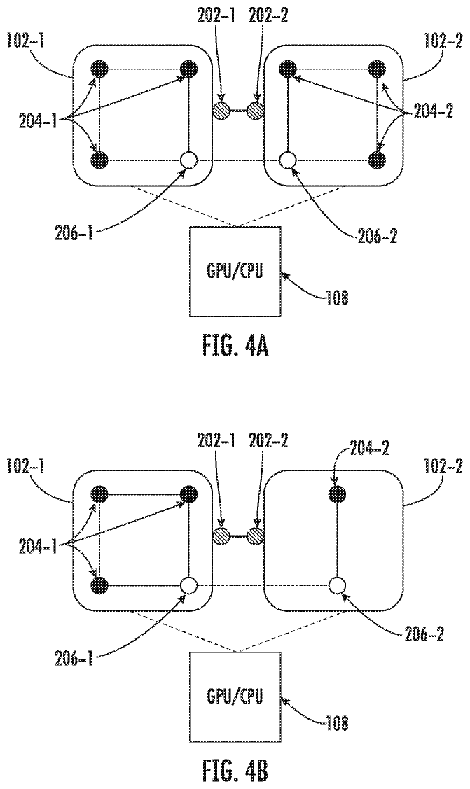

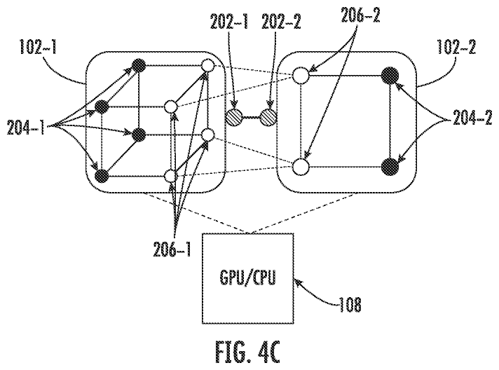

With reference to FIG. 3, the one or more QPUs 102 may each include a plurality of physical qubits propagating across a first plurality of nodes arranged in a square topology. As shown, the plurality of nodes on each of the one or more QPUs 102 may include local nodes 204, and/or global nodes 206. The first plurality of physical qubits may also include synchronization qubits 202. As described in detail above, the local nodes 204 (e.g., local walk nodes) are configured for performing the quantum walks on the QPU 102. In other words, the local nodes 204 may be configured for performing operations associated with the quantum walks locally on a particular QPU 102. In some embodiments, the QPUs 102 may also include global nodes 206 that may be configured to perform the quantum walk in conjunction with other global nodes of other QPUs 102. For example, a global node 206 associated with a first QPU (e.g., first QPU 102-1 in FIGS. 4A-6B) may be configured to perform the operations associated with the quantum walk in conjunction with a global node associated with a second QPU (e.g., second QPU 102-2 in FIGS. 4A-6B). In this way, physical qubits, once having reached a global node 206, would have the ability to be propagated to global nodes 206 on other QPUs 102, thereby expanding the graphical structure upon which the quantum walk is performed. In some embodiments, the global nodes 206 may be entangled (e.g., physical qubits propagating across the global nodes 206 may be, in some instances, entangled).

As described herein, the embodiments of the present disclosure may perform synchronization operations by leveraging the synchronization qubits 202 that define distinct or otherwise independent physical qubits with a sole function of determining if the quantum walk occurring in the distributed quantum computing system 100 is in sync. Said differently, the QPUs 102 of the present disclosure are distinct from conventional systems or devices in that at least a portion of the qubits of each QPU 102 in the distributed quantum computing system 100 includes physical qubits (e.g., synchronization qubits 202) that are independent of the performance of the operations associated with the quantum walk (e.g., such as physical qubits propagating across local nodes 204 and/or global nodes 206).

In some embodiments, the synchronization qubits 202 may be configured to determine if the one or more quantum walks performed on the one or more QPUs 102 are in sync. For example, a synchronization qubit of the first QPU 102-1 and a synchronization qubit of the second QPU 102-2 may be configured to determine if the quantum walks performed on the first QPU 102-1 are in sync with the quantum walks performed on the second QPU 102-2. In some embodiments, once the one or more QPUs 102 receive an instruction from the GPU/CPU 108 to perform the quantum walk, and the physical qubits of each of the one or more QPUs 102 may propagate across the local nodes 204 and/or the global nodes 206 (e.g., commence performance of the quantum walks). As the local nodes 204 and/or global nodes 206 of each of the QPUs 102 undergo the quantum walks, the synchronization qubits 202 of each of the one or more QPUs 102 may be transmitted between the one or more QPUs 102 and configured to determine if the performance of the quantum walks by these distributed QPUs are in sync. In order to determine if the quantum walks are in sync, the distributed quantum computing system 100 may implement a variety of quantum synchronization techniques. For example, the system 100 may determine that respective qubits do not exist on the same timestep for discrete quantum walks, that the QPUs 102 are therefore not in sync. Such a time synchronization may occur at each quantum walk timestep to continuously ensure synchronization. In some embodiments, the synchronization qubits 202 may be entangled.

If the synchronization qubits 202 of each of the QPUs 102 indicate that the quantum walks performed by each QPU 102 are in sync, the one or more QPUs 102 may be instructed to store the data generated by the one or more QPUs 102. In some embodiments, the data generated by the one or more QPUs 102 may be transmitted to the GPU/CPU 108. If the synchronization qubits 202 of each of the QPUs 102 indicate that the quantum walks performed by each QPU 102 are not in sync, the one or more QPUs 102 may restart respective performance of the quantum walks. Said differently, the embodiments described herein allow for the first QPU 102-1 and the second QPU 102-2 in a distributed quantum computing system 100 to operate in parallel to perform the one or more quantum walks.

As described above and shown in FIG. 1, the one or more QPUs 102 of the distributed quantum computing system 100 may be in communication via the quantum channel 104. In some embodiments, the quantum channel 104 may be substantially noiseless (e.g., because the quantum channel does not interact with a classical interconnect or a classical computer). Additionally, as described above the synchronization qubits 202 may be configured to be transmitted between each of the one or more QPUs via the quantum channel 104. In some embodiments, the quantum channel 104 may be embodied by a plurality of fiber optic cables, such as 302A and 302B. In this regard, for example, the plurality of fiber optic cables may be configured to transmit the synchronization qubits 202 as flying qubits (e.g., photon qubits). In some embodiments, the synchronization qubits 202 may be transmitted between the one or more QPUs 102 by a set of fiber optic cables.

With reference to FIGS. 3A-3C, an example QPU 102 of the present disclosure is shown in which physical qubits 300 propagate across a plurality of nodes (e.g., local nodes 204). In particular, FIGS. 3A-3C depict a three (3) qubit QPU 102 that includes one (1) physical qubit 300 propagating across four (4) local nodes 204 encoding two (2) total qubits. In this illustrated example, the physical qubit 300 is initialized on the top left node 204 at time-step zero (T0). After a single time-step, the physical qubit 300 propagates to two adjacent nodes 204, existing as a superposition of all three nodes 204 at (T1). Finally, after another time-step, the physical qubit 300 propagates again across the final node 204, thereby existing as a superposition of all nodes 204 at (T2).

With reference to FIGS. 4A-4C, example two (2) QPU 102 systems are illustrated. As shown in FIG. 4A, the first QPU 102-1 may include three (3) local nodes 204-1, one (1) global node 206-1, and one (1) synchronization qubit 202-1. The second QPU 102-2 may include three (3) local nodes 204-2, one (1) global node 206-2, and one (1) synchronization qubit 202-2. The local nodes 204-1 of the first QPU 102-1 may be configured to perform the one or more quantum walks locally to the first QPU 102-1, and the local nodes 204-2 of the second QPU 102-2 may be configured to perform the one or more quantum walks locally to the second QPU 102-2 as described above. The global nodes 206-1 of the first QPU 102-1 and the global nodes 206-2 of the second QPU 102-2 may operate to allow inter-device quantum walks in which qubits walk between the first QPU 102-1 and the second QPU 102-2. The synchronization qubit 202-1 of the first QPU 102-1 and the synchronization qubit 202-2 of the second QPU 102-2 may operate to determine if the quantum walk performed on the first QPU 102-1 and the quantum walk performed on the second QPU 102-2 are in sync. As shown in FIG. 4B, the first QPU 102-1 may be substantially the same as the first QPU 102-1 of FIG. 4A. The second QPU 102-2, however, may include a single local node 204-2, a single global node 206-2, and a single synchronization qubit 202-2. As shown in FIG. 4C, the first QPU 102-1 may include four (4) local nodes 204-1, four (4) global nodes 206-1, and one (1) synchronization qubit 202-1. The second QPU 102-2 may include two (2) local nodes 204-2, two (2) global nodes 206-2, and one (1) synchronization qubit 202-2.

In this way, the example embodiments of FIGS. 4A-4C illustrate non-limiting examples of particular graphical structures (e.g., formed of a plurality of nodes) for utilizing quantum walks. In other words, the particular graphical structure and/or the particular number of nodes selected for an example two (2) QPU 102 implementation may vary greatly based upon the intended outcome, performance, parameters, etc. associated with the particular system 100. As such, the present disclosure contemplates that a distributed quantum computing system 100 of the present disclosure that includes two (2) QPUs 102 may include any number of respective local nodes 204-1, 204-2, global nodes 206-1, 206-2, and/or synchronization qubits 202-1, 202-2 based upon the intended output of the system 100.

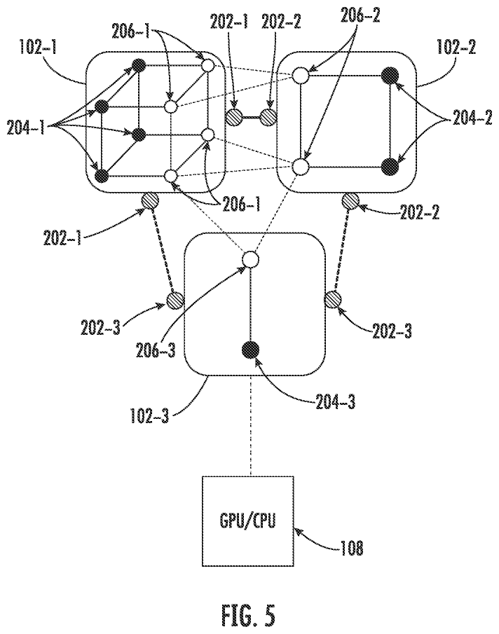

With reference to FIG. 5, an example three (3) QPU 102 system is illustrated. As shown, the first QPU 102-1 may include four (4) local nodes 204-1, four (4) global nodes 206-1, and two (2) synchronization qubits 202-1. The second QPU 102-2 may include two (2) local nodes 204-2, two (2) global nodes 206-2, and two (2) synchronization qubits 202-2. The third QPU 102-3 may include one (1) local node 204-3, one (1) global node 206-3, and two (2) synchronization qubits 202-3. These qubits/nodes may operate similar to those of the two (2) QPUs 102 implementations as described above. In other words, the particular graphical structure and/or the particular number of nodes selected for an example three (3) QPU 102 implementation may also vary greatly based upon the intended outcome, performance, parameters, etc. associated with the particular system 100. As such, the present disclosure contemplates that a distributed quantum computing system 100 of the present disclosure that includes three (3) QPUs 102 may include any number of respective local nodes 204-1, 204-2, 204-3, global nodes 206-1, 206-2, 206-3, and/or synchronization qubits 202-1, 202-2, 202-3 based upon the intended output of the system 100.

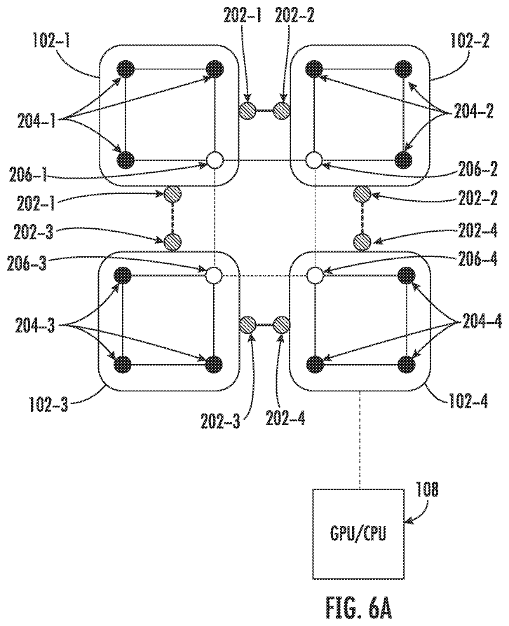

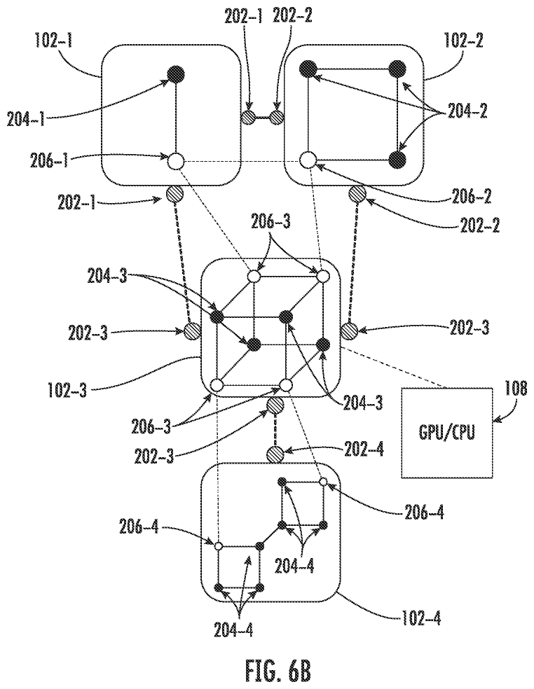

With reference to FIGS. 6A-6B, example four (4) QPU 102 systems are illustrated. As shown in FIG. 6A, the first QPU 102-1 may include three (3) local nodes 204-1, one (1) global node 206-1, and two (2) synchronization qubits 202-1. The second QPU 102-2 may also include three (3) local nodes 204-2, one (1) global node 206-2, and two (2) synchronization qubits 202-2. The third QPU 102-3 may include three (3) local nodes 204-3, one (1) global node 206-3, and two (2) synchronization qubits 202-3. The fourth QPU 102-4 may include three (3) local nodes 204-4, one (1) global node 206-4, and two (2) synchronization qubits 202-4.

As shown in FIG. 6B, the first QPU 102-1 may include one (1) local node 204-1, one global node 206-1, and two (2) synchronization qubits 202-1. The second QPU 102-2 may include three (3) local nodes 204-2, one (1) global node 206-2, and two (2) synchronization qubits 202-2. The third QPU 102-3 may include four (4) local nodes 204-3, four (4) global nodes 206-3, and three (3) synchronization qubits 202-3. The fourth QPU 102-4 may include six (6) local nodes 204-4, two (2) global nodes 206-4, and one (1) synchronization qubit 202-4. These qubits/nodes may operate similar to those of the two (2) QPUs 102 and the three (3) QPUs 102 implementations as described above. In other words, the particular graphical structure and/or the particular number of nodes selected for an example four (4) QPU 102 implementation may also vary greatly based upon the intended outcome, performance, parameters, etc. associated with the particular system 100. As such, the present disclosure contemplates that a distributed quantum computing system 100 of the present disclosure that includes four (4) QPUs 102 may include any number of respective local nodes 204-1, 204-2, 204-3, 204-4, global nodes 206-1, 206-2, 206-3, 206-4, and/or synchronization qubits 202-1, 202-2, 202-3, 202-4 based upon the intended output of the system 100.

### Example GPU/CPU

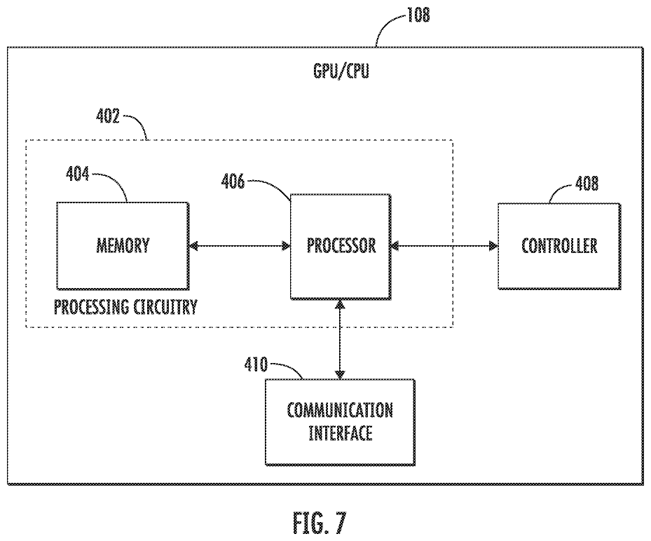

With reference to FIG. 7, a block diagram of the GPU/CPU 108 is illustrated in accordance with some example embodiments. However, it should be noted that the components, devices or elements illustrated in and described with respect to FIG. 7 below may not be mandatory and thus one or more may be omitted in certain embodiments. Additionally, some embodiments may include further or different components, devices or elements beyond those illustrated in and described with respect to FIG. 7.

The GPU/CPU 108 may include or otherwise be in communication with processing circuitry 402 that is configurable to perform actions in accordance with one or more example embodiments disclosed herein. In this regard, the processing circuitry 402 may be configured to perform and/or control performance of one or more functionalities of the GPU/CPU 108 in accordance with various example embodiments, and thus may provide means for performing functionalities of the GPU/CPU 108 in accordance with various example embodiments. The processing circuitry 402 may be configured to perform data processing, application execution and/or other processing and management services according to one or more example embodiments.

In some embodiments, the GPU/CPU 108 or a portion(s) or component(s) thereof, such as the processing circuitry 402, may be embodied as or comprise a chip or chip set. In other words, the GPU/CPU 108 or the processing circuitry 402 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The GPU/CPU 108 or the processing circuitry 402 may therefore, in some cases, be configured to implement an embodiment of the disclosure on a single chip or as a single “system on a chip.” As such, in some cases, a chip or chipset may constitute means for performing one or more operations for providing the functionalities described herein.

In some example embodiments, the processing circuitry 402 may include a processor 406 and, in some embodiments, such as that illustrated in FIG. 7, may further include memory 404. The processing circuitry 402 may be in communication with or otherwise control a communication interface 410 and/or a controller 408. As such, the processing circuitry 402 may be embodied as a circuit chip (e.g., an integrated circuit chip) configured (e.g., with hardware, software or a combination of hardware and software) to perform operations described herein.

The processor 406 may be embodied in a number of different ways. For example, the processor 406 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 406 may comprise a plurality of processors. The plurality of processors may be in operative communication with each other and may be collectively configured to perform one or more functionalities of the GPU/CPU 108 as described herein. The plurality of processors may be embodied on a single computing device or distributed across a plurality of computing devices collectively configured to function as the GPU/CPU 108. In some example embodiments, the processor 406 may be configured to execute instructions stored in the memory 404 or otherwise accessible to the processor 406. As such, whether configured by hardware or by a combination of hardware and software, the processor 406 may represent an entity (e.g., physically embodied in circuitry—in the form of processing circuitry 402) capable of performing operations according to embodiments of the present disclosure while configured accordingly. Thus, for example, when the processor 406 is embodied as an ASIC, FPGA or the like, the processor 406 may be specifically configured hardware for conducting the operations described herein. Alternatively, as another example, when the processor 406 is embodied as an executor of software instructions, the instructions may specifically configure the processor 406 to perform one or more operations described herein.

In some example embodiments, the memory 404 may include one or more non-transitory memory devices such as, for example, volatile and/or non-volatile memory that may be either fixed or removable. In this regard, the memory 404 may comprise a non-transitory computer-readable storage medium. It will be appreciated that while the memory 404 is illustrated as a single memory, the memory 404 may comprise a plurality of memories. The plurality of memories may be embodied on a single computing device or may be distributed across a plurality of computing devices collectively configured to function as the GPU/CPU 108. The memory 404 may be configured to store information, data, applications, instructions and/or the like for enabling the GPU/CPU 108 to carry out various functions in accordance with one or more example embodiments. For example, the memory 404 may be configured to buffer input data for processing by the processor 406. Additionally or alternatively, the memory 404 may be configured to store instructions for execution by the processor 406. As yet another alternative, the memory 404 may include one or more databases that may store a variety of files, contents or data sets. Among the contents of the memory 404, applications may be stored for execution by the processor 406 in order to carry out the functionality associated with each respective application. In some cases, the memory 404 may be in communication with one or more of the processor 406, communication interface 410, or the controller 408 via a bus(es) for passing information among components of the GPU/CPU 108.

In some example embodiments, the GPU/CPU 108 may further include a communication interface 410. In some cases, the communication interface 410 may be any means such as a device or circuitry embodied in either hardware, or a combination of hardware and software that is configured to receive and/or transmit data from/to a network and/or any other device or circuitry in communication with the processing circuitry 402. By way of example, the communication interface 410 may be configured to enable the GPU/CPU 108 to communicate with the one or more QPUs 102 and/or other quantum or classical computing devices. In this regard, for example, the communication interface 410 may be configured to be an analog to quantum communication bridge configured to covert physical layer digital signal representations from and/or to qubit states. The communication interface 410 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the GPU/CPU 108 may include or otherwise control a controller 408. As such, the controller 408 may be embodied as various means, such as circuitry, hardware, a computer program product comprising computer readable program instructions stored on a computer readable medium (for example, the memory 404) and executed by a processing device (for example, the processor 406), or some combination thereof. The controller 408 may be capable of communication with one or more of the memory 404 or communication interface 410 to access, receive, and/or send data as may be needed to perform one or more of the functionalities of the controller 408 as described herein.

### Example Method for Performing Distributed Quantum Computing

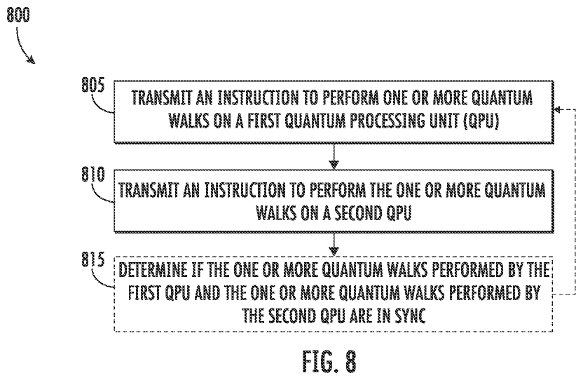

Referring now to FIG. 8, a flowchart providing an example method for performing distributed quantum computing leveraging quantum walks. In some embodiments, the operations illustrated in FIG. 8 may, for example, be performed by, with the assistance of, and/or under the control of a system (e.g., distributed quantum computing system 100), as described above. In this regard, performance of the operations may invoke one or more of processor 406, memory 404, controller 408, communication interface 410, synchronization qubits 202, local nodes 204, and global nodes 206.

As shown in operation 805, the method may include transmitting an instruction to the first QPU to perform one or more quantum walks on the first QPU. As described above, performance of the one or more quantum walks by the local nodes of the first QPU may include conducting the quantum walks across the first plurality of nodes of at least the first QPU. In doing so, the first plurality of nodes described herein operate to form a graphical structure that may vary based upon the intended problem (e.g., quantum algorithm or the like) to be ultimately completed by the system. Furthermore, performance of the one or more quantum walks on the first QPU includes propagation of at least a portion of the first plurality of physical qubits across at least a portion of the plurality of nodes (e.g., local nodes) responsive to one or more inputs from evolution operators (e.g., shift and/or coin operators as described above).

As shown in operation 810, the method may include transmitting an instruction to the second QPU to perform one or more quantum walks on the second QPU. Similar to the first QPU described above with reference to operation 805, performance of the one or more quantum walks by the local nodes of the second QPU may also include conducting the quantum walks across the second plurality of nodes of at least the second QPU. In doing so, the second plurality of nodes described herein operate to form a graphical structure that may vary based upon the intended problem (e.g., quantum algorithm or the like) to be ultimately completed by the system. Furthermore, performance of the one or more quantum walks on the second QPU includes propagation of at least a portion of the second plurality of physical qubits across at least a portion of the second plurality of nodes (e.g., local nodes) responsive to one or more inputs from evolution operators (e.g., shift and/or coin operators as described above).

In some embodiments, as shown in operation 815, the method may include determining if the one or more quantum walks performed by the first QPU and the one or more quantum walks performed by the second QPU are in sync. As described above, as the local nodes and/or global nodes of each of the QPUs perform the quantum walks, the synchronization qubits of each of the one or more QPUs may be transmitted between the one or more QPUs and configured to determine if the performance of the quantum walks by these distributed QPUs are in sync. In order to determine if the quantum walks are in sync, the distributed quantum computing system may implement a variety of quantum synchronization techniques. For example, the system 100 may determine that respective qubits do not exist on the same timestep for discrete quantum walks, that the QPUs 102 are therefore not in sync.

Many modifications and other embodiments of the inventions set forth herein will come to mind to one skilled in the art to which these inventions pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising:
a first quantum processing unit (QPU) configured to perform one or more quantum walks,
wherein the first QPU comprises a first plurality of physical qubits propagating across a first plurality of nodes, and
wherein at least a portion of the first plurality of nodes are local nodes configured to perform the one or more quantum walks on the first QPU.

2. The apparatus according to claim 1, wherein at least a portion of the first plurality of physical qubits are synchronization qubits configured to determine if the one or more quantum walks performed by the first QPU are in sync.

3. The apparatus according to claim 2, wherein the synchronization qubits are independent of the physical qubits propagating across the local nodes performing the one or more quantum walks.

4. The apparatus according to claim 1, further comprising:
a second QPU in communication with the first QPU via a quantum channel and configured to perform the one or more quantum walks,
wherein the second QPU comprises a second plurality of physical qubits propagating across a second plurality of nodes, and
wherein at least a portion of the second plurality of nodes are local nodes configured to perform the one or more quantum walks on the second QPU.

5. The apparatus according to claim 4, wherein the first QPU and the second QPU operate in parallel to perform the one or more quantum walks.

6. The apparatus according to claim 4, wherein:
at least a portion of the second plurality of physical qubits of the second QPU are synchronization qubits; and
the synchronization qubits of the first QPU and the synchronization qubits of the second QPU are further configured to determine if the one or more quantum walks performed by the first QPU and the one or more quantum walks performed by the second QPU are in sync.

7. The apparatus according to claim 6, wherein a portion of the first plurality of nodes of the first QPU are global nodes, and wherein a portion of the second plurality of nodes of the second QPU are global nodes, wherein the global nodes of the first QPU are configured to perform the one or more quantum walks in conjunction with the global nodes of the second QPU.

8. The apparatus according to claim 7, wherein at least a portion of the first plurality of physical qubits of the first QPU and at least a portion of the second plurality of physical qubits of the second QPU are entangled.

9. The apparatus according to claim 1, wherein the one or more quantum walks are discrete-time quantum walks or continuous-time quantum walks.

10. The apparatus according to claim 1, wherein the one or more quantum walks are conducted across the first plurality of nodes of at least the first QPU so as to form a graphical structure.

11. The apparatus according to claim 10, wherein performance of the one or more quantum walks on the first QPU comprises propagation of at least a portion of the first plurality of physical qubits across the first plurality of nodes responsive to one or more inputs from evolution operators.

12. The apparatus according to claim 4, further comprising a computer processing device in communication with the first QPU and the second QPU, wherein the computer processing device is configured to receive data generated by the one or more quantum walks performed by the first QPU and the second QPU.

13. A method comprising:
transmitting an instruction to perform one or more quantum walks on a first quantum processing unit (QPU), wherein the first QPU comprises a first plurality of physical qubits propagating across a first plurality of nodes, wherein at least a portion of the first plurality of nodes are local nodes configured to perform the one or more quantum walks on the first QPU; and
transmitting an instruction to perform the one or more quantum walks on a second QPU, wherein the second QPU comprises a second plurality of physical qubits propagating across a second plurality of nodes, wherein at least a portion of the second plurality of nodes are local nodes configured to perform the one or more quantum walks on the second QPU.

14. The method according to claim 13, wherein at least a portion of the first plurality of physical qubits comprise synchronization qubits and at least a portion of the second plurality of qubits comprise synchronization qubits, wherein the synchronization qubits of the first QPU and the synchronization qubits of the second QPU are configured to determine if the one or more quantum walks performed by the first QPU and the one or more quantum walks performed by the second QPU are in sync.

15. The method according to claim 14, wherein at least a portion of the first plurality of nodes of the first QPU are global nodes and at least a portion of the second plurality of nodes of the second QPU are global nodes, wherein the global nodes of the first QPU are configured to perform the one or more quantum walks in conjunction with the global nodes of the second QPU.

16. The method according to claim 15, wherein at least a portion of the first plurality of physical qubits of the first QPU and at least a portion of the second plurality of physical qubits of the second QPU are entangled.

17. The method according to claim 14, in an instance in which the one or more quantum walks performed by the first QPU and the one or more quantum walks performed by the second QPU are in sync, further comprising receiving data generated by the one or more quantum walks performed by the first QPU and the second QPU.

18. The method according to claim 13, wherein the one or more quantum walks are discrete-time quantum walks or continuous-time quantum walks.

19. The method according to claim 13, wherein the one or more quantum walks are conducted across the first plurality of nodes of the first QPU and the second plurality of nodes of the second QPU so as to form respective first and second graphical structures.

20. The method according to claim 19, wherein:
performance of the one or more quantum walks on the first QPU comprises propagation of at least a portion of the first plurality of physical qubits across the first plurality of nodes of the first graphical structure responsive to one or more inputs from evolution operators; and
performance of the one or more quantum walks on the second QPU comprises propagation of at least a portion of the second plurality of physical qubits across the second plurality of nodes of the second graphical structure responsive to one or more inputs from the evolution operators.
